(19) United States
(12) Patent Application Publication
(10) Pub. No.: US 2026/0119954 A1
(43) Pub. Date: Apr. 30, 2026

(54) METHOD FOR TRAINING QUANTUM NEURAL NETWORK AND METHOD FOR CLASSIFYING DATA

(71) Applicant: CHINA UNIONPAY CO., LTD., Shanghai (CN)

(72) Inventors: Boxuan AI, Shanghai (CN); Tao TANG, Shanghai (CN); Yanming YANG, Shanghai (CN); Pengfei GAO, Shanghai (CN); Jianbin ZHENG, Shanghai (CN)

(21) Appl. No.: 19/489,065

(22) PCT Filed: Mar. 20, 2024
(86) PCT No.: PCT/CN2024/082598

§ 371 Date: Dec. 1, 2025

(30) Foreign Application Priority Data
May 30, 2023 (CN) 202310626399.3

(51) Int. Cl. G06N 10/60

(52) U.S. Cl. CPC G06N 10/60

(57) ABSTRACT

A method for training a quantum neural network and a method for classifying data are disclosed in the present disclosure. The method for training the quantum neural network includes acquiring sample data and a sample category label corresponding to the sample data, performing feature extraction on the sample data using a feature extraction layer of the quantum neural network, inputting the sample feature obtained by extracting into a unitary matrix layer to obtain a unitary matrix corresponding to the sample feature, adjusting a quantum state of a first qubit based on the unitary matrix to obtain a second qubit, the quantum state of the first qubit corresponds to the sample category label; determining a quantum state fidelity between the second qubit and the first qubit using the quantum circuit and then determining a loss value.

### CROSS-REFERENCE TO RELATED APPLICATIONS

The present application is a National Stage of International Application No. PCT/CN2024/082598 filed on Mar. 20, 2024, which claims priority to Chinese patent application No. 202310626399.3 entitled “METHOD FOR TRAINING QUANTUM NEURAL NETWORK AND METHOD FOR CLASSIFYING DATA” filed on May 30, 2023, both of which are incorporated herein by reference in their entireties.

### TECHNICAL FIELD

The present disclosure relates to the technical field of quantum computing, particularly to a method for training a quantum neural network and a method for classifying data.

### BACKGROUND

A traditional neural network, also simply referred to as a neural network, is an artificial intelligence system composed of numerous neurons connected by adjustable connection weights, processing capabilities of large-scale parallel processing, distributed information storage, and excellent self-organizing and self-learning.

With the development of quantum computing science, the neural network has been combined with the quantum computing science to develop a novel quantum neural network. Classical quantum neural network relies on technologies such as quantum state preparation of data and the quantum state data storage. However, the quantum state preparation process often consumes additional time and space complexity, while the quantum state data storage presents a significant technical challenge, resulting in high training difficulty and complexity for the quantum neural network. Furthermore, the classical quantum neural network often requires a large number of qubits to represent different data, and too many qubits not only lead to high computational costs but also cause the barren plateaus phenomenon during training.

### SUMMARY

Embodiments of the present disclosure provide a method for training a quantum neural network and a method for classifying data, which can reduce the training difficulty and complexity of the quantum neural network, reduce the computational cost of the quantum neural network, and reduce the probability of occurring of the barren plateaus phenomenon.

In a first aspect, some embodiments of the present disclosure provide a method for training a quantum neural network. The method for training the quantum neural network includes:
acquiring sample data for training the quantum neural network and a sample category label corresponding to the sample data, the quantum neural network including a feature extraction layer, a unitary matrix layer, and a quantum circuit;
performing feature extraction on the sample data using the feature extraction layer to obtain a sample feature;
inputting the sample feature into the unitary matrix layer to obtain a unitary matrix corresponding to the sample feature;
adjusting a quantum state of a first qubit based on the unitary matrix to obtain a second qubit, the quantum state of the first qubit corresponding to the sample category label;
determining a quantum state fidelity between the second qubit and the first qubit using the quantum circuit, and determining a loss value based on the quantum state fidelity; and
adjusting a network parameter in the quantum neural network based on the loss value, and returning to execute the acquiring the sample data for training the quantum neural network and the sample category label corresponding to the sample data until the quantum neural network converges, so as to obtain the trained quantum neural network.

In a second aspect, some embodiments of the present disclosure provide a method for classifying data. The method for classifying data includes:
acquiring target data to be classified, and inputting the target data into a quantum neural network, the quantum neural network including a feature extraction layer, a unitary matrix layer, and a quantum circuit;
performing feature extraction on the target data using the feature extraction layer to obtain a target data feature;
inputting the target data feature into the unitary matrix layer to obtain a unitary matrix corresponding to the target data feature;
adjusting a quantum state of a fifth qubit based on the unitary matrix to obtain a sixth qubit;
determining a quantum state fidelity between the sixth qubit and the fifth qubit using the quantum circuit; and
determining a category to which the target data belongs based on the quantum state fidelity.

In a third aspect, some embodiments of the present disclosure provide an apparatus for training a quantum neural network. The apparatus for training the quantum neural network includes:
a sample acquisition module, configured to acquire sample data for training the quantum neural network and a sample category label corresponding to the sample data, the quantum neural network including a feature extraction layer, a unitary matrix layer, and a quantum circuit;
a first extraction module, configured to perform feature extraction on the sample data using the feature extraction layer to obtain a sample feature;
a first determination module, configured to input the sample feature into the unitary matrix layer to obtain a unitary matrix corresponding to the sample feature;
a first adjustment module, configured to adjust a quantum state of a first qubit based on the unitary matrix to obtain a second qubit, the quantum state of the first qubit corresponding to the sample category label;
a loss determination module, configured to determine a quantum state fidelity between the second qubit and the first qubit using the quantum circuit, and determine a loss value based on the quantum state fidelity; and
a parameter adjustment module, configured to adjust a network parameter in the quantum neural network based on the loss value, and return to execute the acquiring the sample data for training the quantum neural network and the sample category label corresponding to the sample data until the quantum neural network converges, so as to obtain the trained quantum neural network.

In a fourth aspect, some embodiments of the present disclosure provide an apparatus for classifying data. The apparatus for classifying data includes:
a data acquisition module, configured to acquire target data to be classified, and input the target data into a quantum neural network, the quantum neural network including a feature extraction layer, a unitary matrix layer, and a quantum circuit;
a second extraction module, configured to perform feature extraction on the target data using the feature extraction layer to obtain a target data feature;
a second determination module, configured to input the target data feature into the unitary matrix layer to obtain a unitary matrix corresponding to the target data feature;
a second adjustment module, configured to adjust a quantum state of a fifth qubit based on the unitary matrix to obtain a sixth qubit;
a fidelity determination module, configured to determine a quantum state fidelity between the sixth qubit and the fifth qubit using the quantum circuit; and
a category determination module, configured to determine a category to which the target data belongs based on the quantum state fidelity.

In a fifth aspect, some embodiments of the present disclosure provide an electronic device. The electronic device includes a processor and a memory storing computer program instructions. The processor, when executing the computer program instructions, implements the steps of the method for training the quantum neural network provided in any one embodiment in the first aspect, or the steps of the method for classifying data provided in any one embodiment in the second aspect.

In a sixth aspect, some embodiments of the present disclosure provide a computer-readable storage medium storing computer program instructions. The computer program instructions, when executed by a processor, implement the steps of the method for training the quantum neural network provided in any one embodiment in the first aspect, or the steps of the method for classifying data provided in any one embodiment in the second aspect.

In a seventh aspect, some embodiments of the present disclosure provide a computer program product. Instructions in the computer program product, when executed by a processor of an electronic device, cause the electronic device to perform the steps of the method for training the quantum neural network provided in any one embodiment in the first aspect, or the steps of the method for classifying data provided in any one embodiment in the second aspect.

### BRIEF DESCRIPTION OF THE DRAWINGS

To more clearly illustrate the technical solutions of the embodiments of the present disclosure, the drawings used in the embodiments of the present disclosure will be briefly introduced below. For those skilled in the art, other drawings can be obtained based on these drawings without creative effort.

FIG. 1 is a flowchart of a method for training a quantum neural network provided by an embodiment of the present disclosure;

FIG. 2 is a network structural diagram of the quantum neural network provided by the present disclosure;

FIG. 3 is an equivalent diagram of a quantum circuit provided by the present disclosure;

FIG. 4 is a flowchart of a method for classifying data provided by an embodiment of the present disclosure;

FIG. 5 is a schematic structural diagram of an apparatus for training the quantum neural network provided by an embodiment of the present disclosure;

FIG. 6 is a schematic structural diagram of an apparatus for classifying data provided by an embodiment of the present disclosure; and

FIG. 7 is a schematic structural diagram of an electronic device provided by an embodiment of the present disclosure.

### DETAILED DESCRIPTION

The features and exemplary embodiments of various aspects of the present disclosure will be described in detail below. To make the purposes, technical solutions, and advantages of the present disclosure clearer and more understandable, the present disclosure will be further described in detail below with reference to the drawings and specific embodiments. It should be understood that the specific embodiments described herein are intended only to explain the present disclosure and not to limit the present disclosure. For those skilled in the art, the present disclosure can be implemented without some of the details described herein. The following description of the embodiments is intended solely to provide a better understanding of the present disclosure by illustrating examples of the present disclosure.

It should be noted that, in the present disclosure, relational terms such as “first” and “second” are used merely to distinguish one entity or operation from another, and do not necessarily require or imply any such actual relationship or sequence between the entities or operations. Moreover, the terms “comprising,” “including,” or any other variations thereof are intended to cover non-exclusive inclusion, so that a process, method, article, or device including a series of elements includes not only those elements but also includes other elements not explicitly listed or elements inherent to such process, method, article, or device. Without further limitation, the elements defined by the phrase “including . . . ” do not exclude additional identical elements in the process, method, article, or device that includes these elements.

To address the technical problems of the prior art, the embodiments of the present disclosure provide a method for training a quantum neural network and a method for classifying data. The method for training the quantum neural network can be applied to scenarios for training the quantum neural network. The method for training the quantum neural network provided by some embodiments of the present disclosure is firstly described below.

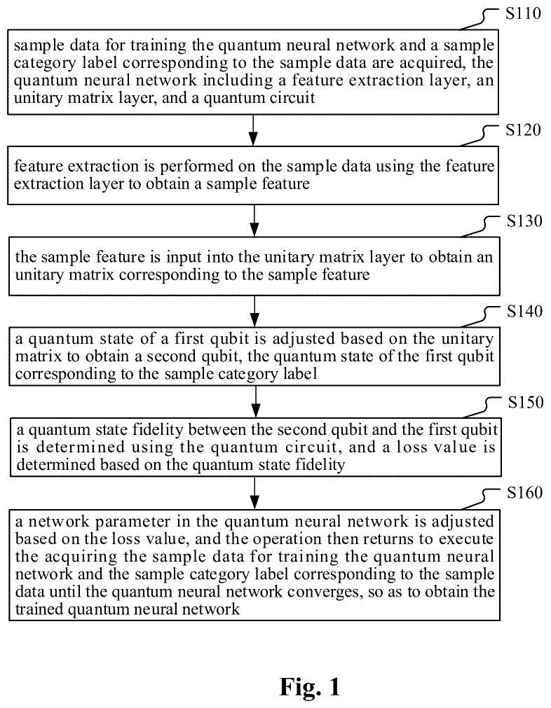

FIG. 1 is a flowchart of a method for training a quantum neural network provided by an embodiment of the present disclosure. As shown in FIG. 1, the method for training the quantum neural network specifically includes S110, S120, S130, S140, S150, and S160.

In S110: sample data for training the quantum neural network and a sample category label corresponding to the sample data are acquired, the quantum neural network including a feature extraction layer, a unitary matrix layer, and a quantum circuit.

In S120: feature extraction is performed on the sample data using the feature extraction layer to obtain a sample feature.

In S130: the sample feature is input into the unitary matrix layer to obtain a unitary matrix corresponding to the sample feature.

In S140: a quantum state of a first qubit is adjusted based on the unitary matrix to obtain a second qubit, the quantum state of the first qubit corresponding to the sample category label.

In S150: a quantum state fidelity between the second qubit and the first qubit is determined using the quantum circuit, and a loss value is determined based on the quantum state fidelity.

In S160: a network parameter in the quantum neural network is adjusted based on the loss value, and the operation then returns to execute the acquiring of the sample data for training the quantumneural network and the sample category label corresponding to the sample data until the quantum neural network converges, so as to obtain the trained quantum neural network.

Therefore, the structure of the quantum neural network is improved by providing the feature extraction layer, the unitary matrix layer, and the quantum circuit in the quantum neural network. Then, during the training process, the sample feature extracted from the feature extraction layer and corresponding to the sample data is directly input into the unitary matrix layer, the unitary matrix corresponding to the sample feature is prepared to replace the preparation of quantum state data in the traditional method, the first qubit serves as a substitute for the activation function, so that the quantum state of the first qubit is adjusted to be flipped by the unitary matrix; after obtaining the second qubit, a similarity comparison between the second qubit and the first qubit is performed by the quantum circuit to calculate the loss function. In this way, in the embodiments of the present disclosure, the quantum neural network can be obtained through training without quantum state preparation, quantum state data storage, or excessive qubits, which can reduce the training difficulty and complexity of the quantum neural network, reduce the computational cost of the quantum neural network, and reduce the probability of occurring of the barren plateaus phenomenon.

The specific implementation methods for the aforementioned respective steps are described below.

In some embodiments, in S110, a training set Dₜᵣₐᵢₙ including M pieces of sample data can be provided, where M is an integer greater than 1. On such basis, a feature item in the training set Dₜᵣₐᵢₙ can be represented as \vec{x}=(\vec{x₁}, \vec{x₂}, . . . , \vec{x_{M}}), where the feature item corresponding to the m-th piece of sample data is \vec{xₘ}, where 1≤m≤M. One piece of sample data can be provided with one sample category label, so that a label item corresponding to the training set Dₜᵣₐᵢₙ can be \vec{y}=(y₁, y₂, . . . , y_{M}).

Additionally, the sample data can be selected according to the usage scenario for the quantum neural network. For example, under a condition that the quantum neural network is configured to predict merchant lending risks, the sample data can be selected from relevant data of risky merchants and relevant data of non-risky merchants, and the sample category labels can include risky and non-risky merchants.

Exemplarily, after obtaining the training set Dₜᵣₐᵢₙ, each training iteration can retrieve one piece of sample data \vec{xₘ} and one sample category label yₘ corresponding to the sample data \vec{xₘ} from the training set Dₜᵣₐᵢₙ.

In some embodiments, in S120, different from the structure of the traditional quantum neural network, the quantum neural network provided in the embodiments of the present disclosure can include the feature extraction layer, the unitary matrix layer, and the quantum circuit. The feature extraction layer can be a structure in the traditional neural network configured to process conventional data, and can include an input layer and a hidden layer. Specifically, the input layer can be configured to receive data to be input into the quantum neural network, and the hidden layer can be configured to map the input data to another dimensional space to extract a feature of the input data.

Exemplarily, the sample data can be input into the quantum neural network via the input layer, and feature extraction is performed on the input sample data by the hidden layer, so as to output the sample feature corresponding to the sample data.

On such basis, under a condition that the sample data includes N feature data points corresponding to N dimensions, in order to further improve the accuracy of feature extraction, in some embodiments, K hidden units can be provided in the feature extraction layer, where N and K are integers greater than 1.

Exemplarily, each piece of sample data can include feature data points of N dimensions. That is, the m-th piece of sample data in the training set Dₜᵣₐᵢₙ can be represented as \vec{xₘ}=(xₘ₁, xₘ₂, . . . , x_{mN}), and one feature data on the n-th dimension in the m-th piece of sample data is xₘₙ, where 1≤n≤N. Additionally, the number of the hidden units, K, can be set by the user based on the actual usage scenario for the quantum neural network.

On such basis, in some embodiments, the above S120 can specifically include: inputting the N feature data points into each of the K hidden units, and performing feature extraction on the N feature data points using each hidden unit, so as to obtain K sample sub-features, the sample feature including the K sample sub-features.

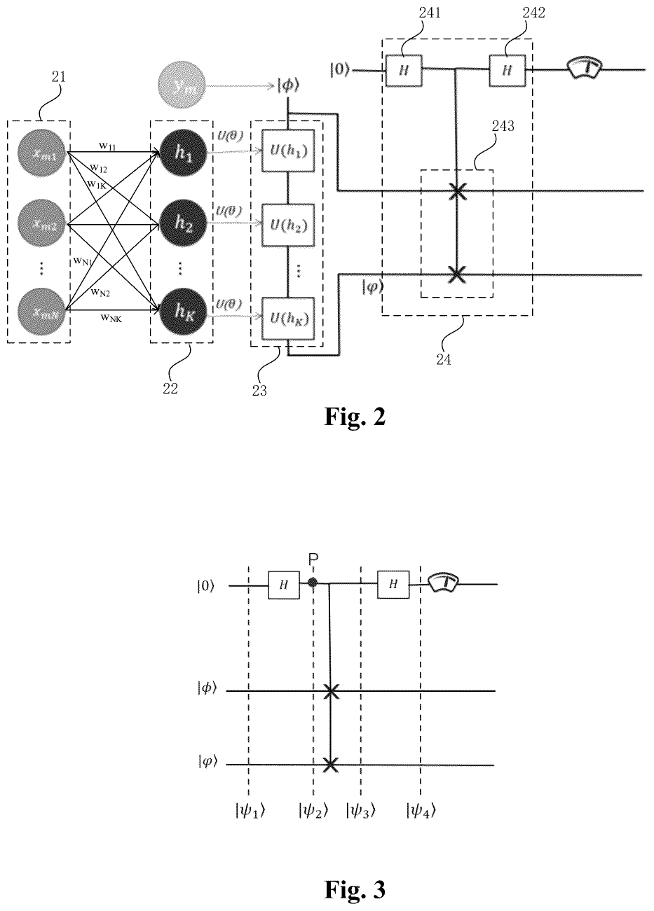

Exemplarily, a structure of the quantum neural network provided by some embodiments of the present disclosure can be as shown in FIG. 2. For the feature data points 21 of N dimensions in the sample data \vec{xₘ}, the feature data points 21 of N dimensions can be input into each hidden unit in the hidden layer 22.

For example, the feature data points 21 of N dimensions are input into a hidden unit h₁ in the hidden layer 22, and feature extraction is performed on the N feature data points using the hidden unit h₁ to obtain one sample sub-feature output by the hidden unit h₁; the feature data points 21 of N dimensions are input into a hidden unit h₂ in the hidden layer 22, and feature extraction is performed on the N feature data points using the hidden unit h₂ to obtain one sample sub-feature output by the hidden unit h₂; . . . ; the feature data points 21 of N dimensions are input into a hidden unit h_{K} in the hidden layer 22, and feature extraction is performed on the N feature data points using the hidden unit h_{K} to obtain one sample sub-feature output by the hidden unit h_{K}. In this way, K sample sub-features can be obtained.

Here, assuming the input is the m-th piece of sample data, a calculation formula corresponding to the k-th hidden unit in the hidden layer can be expressed as the following formula (1):

$${h}_{k} = {w}_{1 k} {x}_{m 1} + {w}_{2 k} {x}_{m 2} + … + {w}_{Nk} {x}_{mN} + {b}_{mk} \qquad ( 1 )$$

where 1≤k≤K, a weight of a connection line between the feature data point of the n-th dimension and the k-th hidden unit is wₙₖ, and a bias item for the k-th hidden unit is bₘₖ. The sample sub-feature output by the k-th hidden unit can be a corresponding value of hₖ.

In some embodiments, in S130 and S140, an evolution of the quantum state can be described by unitary transformation, and the unitary matrix layer can be configured to perform unitary transformation on the first qubit based on the sample feature.

For example, under a condition that the quantum state of the qubit at time t₁ is |−|φ₁ [symbol] , the quantum state of the qubit at time t₂ becomes |φ₂ [symbol] after undergoing a unitary transformation U. This process can be described as: |φ₂ [symbol] =U|φ₁ [symbol] . The unitary transformation U can be understood as a matrix satisfying U^{†}U=1 (unitary positivity), i.e., the product of U and its conjugate transpose matrix U^{†} equals to 1. In the quantum computing field, various forms of unitary matrices are referred to as quantum gates.

Exemplarily, the sample feature can be directly input into the unitary matrix to cause the unitary matrix to be changed to obtain a unitary matrix corresponding to this sample feature, the unitary matrix is then applied to the first qubit to cause the quantum state of the first qubit to be flipped to obtain the second qubit. The first qubit can be a unit qubit and has a quantum state corresponding to a sample category label for the sample data.

For example, under a condition that the sample category label is a binary classification label, such as a label A corresponding to category a and a label B corresponding to category b, a relationship between the quantum state |φ [symbol] of the first qubit and the sample category label can be defined by the following formula (2):

$$\vert ϕ 〉 = \{ \begin{matrix}\vert 0 〉 , & {y}_{m} belonging to A \\ \vert 1 〉 , & {y}_{m} belonging to B\end{matrix} \qquad ( 2 )$$

That is, under a condition that the sample data belongs to category a and its corresponding sample category label is label A, a ground state qubit with the quantum state |0 [symbol] can be selected as the first qubit; and under a condition that the sample data belongs to category b and its corresponding sample category label is label B, a ground state qubit with the quantum state |1 [symbol] can be selected as the first qubit, where | [symbol] denotes a Dirac symbol and represents a vector in Hilbert space,

$$\vert 0 〉 = ( \begin{matrix}1 \\ 0\end{matrix} ) , and \vert 1 〉 = ( \begin{matrix}0 \\ 1\end{matrix} ) .$$

On such basis, under a condition that the hidden layer includes K hidden units, i.e., under a condition that the sample feature includes K sample sub-features output from the K hidden units, in some embodiments, the above S130 can specifically include: inputting the K sample sub-features into the unitary matrix layer to obtain K unitary matrices corresponding to the K sample sub-features.

Here, one sample sub-feature can correspond and be computed to obtain one unitary matrix.

On such basis, in some embodiments, an expression for the unitary matrix layer in some embodiments of the present disclosure can be represented by a formula (3):

$$U ( θ ) = [ \begin{matrix}a \cdot cos ( θ ) & β \cdot sin ( θ ) \\ - {β}^{- 1} \cdot sin ( θ ) & {a}^{- 1} \cdot cos ( θ )\end{matrix} ] \qquad ( 3 )$$

where α and β can be adjustment parameters, θ can be an input feature, and U(θ) can be the unitary matrix corresponding to the input feature. When inputting the sample feature into the unitary matrix layer, θ can be the input sample feature, and θ can be the input sample sub-features under a condition that the sample feature includes K sample sub-features. In this way, unitary matrices corresponding to the K sample sub-features can be obtained, and the K unitary matrices can form a unitary matrix group U(h₁)U(h₂) . . . U(h_{K}), such as the unitary matrix group 23 shown in FIG. 2.

Additionally, in some embodiments, a value of each adjustment parameter can be determined based on the data feature for the sample data.

Exemplarily, α and β each serve as a leading term to prevent data from being too small and are typically set to 1. For example, in merchant transaction data points, since both transaction amounts and percentages are substantial, there is no need to add amplitude α and β. Conversely, data sometimes is small (e.g., input sample feature being 0.1%), which may cause the first qubit to be deflected insignificantly. On such basis, in combination with measurement errors and noise, measurement may be not be performed. In this case, β is set to be 1000 to increase the value, so that the deflection of the first qubit is more obvious.

Additionally, in some implementations, under a condition that the K unitary matrices is obtained, S140 can specifically include: multiplying the K unitary matrices by the first qubit to obtain the second qubit.

Here, a quantum state |φ [symbol] of the second qubit can be calculated using the following formula (4):

$$\vert φ 〉 = U ( {h}_{1} ) U ( {h}_{2} ) … U ( {h}_{K} ) \vert ϕ 〉 = ( {\prod }_{i = 1}^{K} U ( {h}_{i} ) ) \vert ϕ 〉 \qquad ( 4 )$$

where |φ [symbol] denotes the quantum state of the first qubit and is 2×1 matrix, U(h₁)U(h₂) . . . U(h_{K}) denotes a unitary matrix group formed by K unitary matrices, and

$$( {\prod }_{i = 1}^{K} U ( {h}_{i} ) )$$

is a 2×2 matrix. According to the matrix multiplication principle, |φ [symbol] is also a 2×1 matrix.

Exemplarily, as shown in FIG. 2, after multiplying the quantum state |φ [symbol] of the first qubit by the K unitary matrices, the quantum state |φ [symbol] of the second qubit can be obtained.

In some embodiments, in S150, the quantum circuit can compare the quantum state of the unit qubit (i.e., the second qubit) after being adjusted by flipping the unitary matrix group with the quantum state of the first qubit to determine a similarity | [symbol] φ| [symbol] |² between the quantum state of the second qubit and the quantum state of the first qubit, i.e., the quantum state fidelity, which can also be expressed as a probability that the next quantum state is |φ [symbol] when an initial quantum state is |φ [symbol] . Here, [symbol] φ| denotes a conjugate transpose matrix of |φ [symbol] , [symbol] φ| is a 1×2 matrix, and | [symbol] φ|φ [symbol] |² is a 1×1 array, i.e., a polynomial. A structure of the quantum circuit can be any structure capable of constructing | [symbol] φ|φ| [symbol] |².

On such basis, in order to construct | [symbol] φ|φ [symbol] |², in some examples, the quantum circuit can include a first Hadamard gate, a second Hadamard gate, and a swap gate. Accordingly, the aforementioned S150 can specifically include:
inputting a preset third qubit into the first Hadamard gate to output to obtain a first intermediate-state qubit;
inputting the first qubit and the second qubit into the swap gate, controlling the swap gate with the first intermediate-state qubit, and outputting to obtain a second intermediate-state qubit;
inputting the second intermediate-state qubit into the second Hadamard gate and outputting to obtain a fourth qubit;
measuring a quantum state of the fourth qubit multiple times to obtain measurement results;
determining, based on the measurement results, a probability value that the measurement results are a third quantum state, the third quantum state being a quantum state of the third qubit; and
calculating the quantum state fidelity between the first qubit and the second qubit based on the probability value.

Here, as shown in FIG. 2, the quantum neural network provided by some embodiments of the present disclosure can include a quantum circuit 24, and the quantum circuit 24 can specifically include a first Hadamard gate 241, a second Hadamard gate 242, and a swap gate 243. The quantum gates can be arranged in the sequence of circuit elements shown in FIG. 2. The first Hadamard gate 241 and second Hadamard gate 242 can be Hadamard gates whose expression is

$$H = \frac{1}{\sqrt{2}} [ \begin{matrix}1 & 1 \\ 1 & - 1\end{matrix} ] .$$

The swap gate 243 is

$$[ \begin{matrix}1 & 0 & 0 & 0 \\ 0 & 0 & 1 & 0 \\ 0 & 1 & 0 & 0 \\ 0 & 0 & 0 & 1\end{matrix} ] .$$

Additionally, the third qubit can be a unit qubit with a quantum state of |0 [symbol] or |1 [symbol] , which is set by a user by default. After being processed by the first Haddamade gate, the third qubit can be configured to control the swap gate.

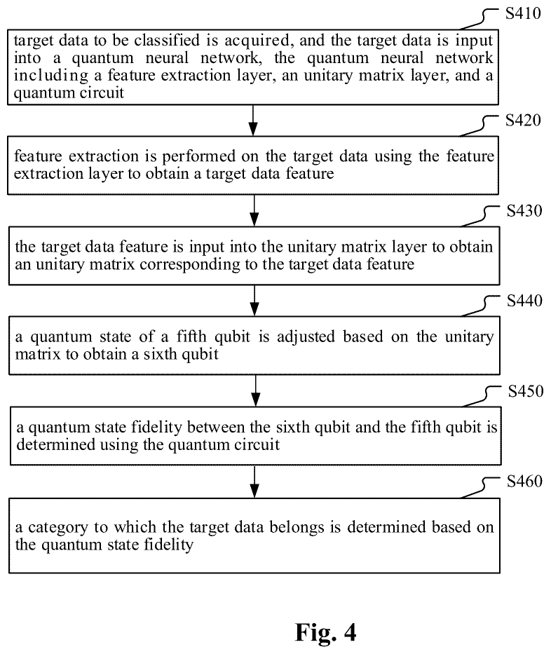

Exemplarily, in order to facilitate the explanation of a computational process of the quantum circuit, the quantum circuit 24 in FIG. 2 can be divided into four parts: |ψ₁ [symbol] , |ψ₂ [symbol] , |ψ₃ [symbol] , and |ψ₄ [symbol] , which are shown in FIG. 3. Specifically, the inputs of the quantum circuit are three qubits, i.e., the first qubit, the second qubit, and the third qubit. The principle of this quantum circuit lies in control of point P (i.e., the first intermediate-state qubit) over the swap gate. Taking the quantum state of the third qubit being |0 [symbol] as an example, the quantum state at point P can be expressed as

$$H \vert 0 〉 = \frac{1}{\sqrt{2}} ( \vert 0 〉 + \vert 1 〉 ) ,$$

i.e., the probability that the quantum state of the first intermediate-state qubit is |1 [symbol] is 50%, and the probability that the quantum state of the first intermediate-state qubit is |0 [symbol] is 50%.

On such basis, as shown in FIG. 3, taking the quantum state of the first qubit being |φ [symbol] , the quantum state of the second qubit being |φ [symbol] , and the quantum state of the third qubit being |0 [symbol] as an example, an input state |ψ₁ [symbol] of the quantum circuit can be expressed as the follow expression (5):

$$\vert {ψ}_{1} 〉 = \vert 0 〉 \vert φ 〉 \vert ϕ 〉 \qquad ( 5 )$$

After the third qubit |0 [symbol] in the input state |ψ₁ [symbol] passes through the first H gate, i.e., the first Hadamard gate, the input state |ψ₁ [symbol] can be transformed into the quantum state |ψ₂ [symbol] , which can be expressed as the follow expression (6):

$$\vert {ψ}_{2} 〉 = H \vert 0 〉 \vert φ 〉 \vert ϕ 〉 = \frac{1}{\sqrt{2}} ( \vert 0 〉 + \vert 1 〉 ) \vert φ 〉 \vert ϕ 〉 = \frac{1}{\sqrt{2}} ( \vert 0 〉 \vert φ 〉 \vert ϕ 〉 + \qquad ( 6 )$$

$$\vert 1 〉 \vert φ 〉 \vert ϕ 〉 )$$

where H|0 [symbol] represents the first intermediate-state qubit.

After passing through another swap gate, the quantum state |ψ₂ [symbol] can be transformed into the quantum state |ψ₃ [symbol] , which is the quantum state of the second intermediate-state qubit. This quantum state |ψ₃ [symbol] can be expressed as the following expression (7):

$$\vert {ψ}_{3} 〉 = \frac{1}{\sqrt{2}} ( \vert 0 〉 \vert φ 〉 \vert ϕ 〉 + \vert 1 〉 \vert ϕ 〉 \vert φ 〉 ) \qquad ( 7 )$$

where under a condition that the quantum state at point P (i.e., the first intermediate-state qubit) is |1 [symbol] , the positions of |φ [symbol] and |φ [symbol] are swapped, i.e., the positions of |φ [symbol] and |0 [symbol] in |1 [symbol] |φ [symbol] |φ [symbol] in the expression (6) are swapped, and |1 [symbol] |φ [symbol] |φ [symbol] in the expression (6) is changed into |1 [symbol] | [symbol] |φ [symbol] in the expression (7). When the quantum state at point P is |0 [symbol] , the positions of |φ [symbol] and | φ [symbol] are not swapped.

After inputting the second intermediate-state qubit into the second H gate (i.e., the second Hadamard gate), the second intermediate-state qubit can be transformed into a fourth qubit with a quantum state |ψ₄ [symbol] , which can be expressed as the following expression (8):

$$\vert {ψ}_{4} 〉 = H \vert {ψ}_{3} 〉 = \frac{1}{\sqrt{2}} H ( \vert 0 〉 \vert φ 〉 \vert ϕ 〉 + \vert 1 〉 \vert ϕ 〉 \vert φ 〉 ) = \frac{1}{2} [ \vert 0 〉 ( \vert ϕ 〉 \vert φ 〉 + \qquad ( 8 )$$

$$\vert φ 〉 \vert ϕ 〉 ) + \vert 1 〉 ( \vert ϕ 〉 \vert φ 〉 - \vert φ 〉 \vert ϕ 〉 ) ]$$

The quantum state |ψ₄ [symbol] of the fourth qubit is measured and the obtained measurement result can be expressed as the following expression (9):

$$( \vert 0 〉 〈 0 \vert ⊗ I ) \frac{1}{2} [ \vert 0 〉 ( \vert ϕ 〉 \vert φ 〉 + \vert φ 〉 \vert ϕ 〉 ) + \vert 1 〉 ( \vert ϕ 〉 \vert φ 〉 - \vert φ 〉 \vert ϕ 〉 ) ] = \frac{1}{2} [ \vert 0 〉 ⊗ ( \vert ϕ 〉 \vert φ 〉 + \vert φ 〉 \vert ϕ 〉 ) ] \qquad ( 9 )$$

where I denotes an identity matrix.

On such basis, a probability value Prob(0) that the measurement result is |0 [symbol] can be calculated using the following formula (10):

$${Prob ( 0 ) = \vert \frac{1}{2} [ \vert 0 〉 ⊗ ( \vert ϕ 〉 \vert φ 〉 + \vert φ 〉 \vert ϕ 〉 ) ] \vert}^{2} = \frac{1}{2} ( 1 + {\vert 〈 ϕ \vert φ 〉 \vert}^{2} ) \qquad ( 10 )$$

In this way, the output of the quantum circuit, i.e., the quantum state of the fourth qubit is measured multiple times to obtain the probability value Prob(0) that the measurement result is |0 [symbol] . Then, conversely, the quantum state fidelity | [symbol] φ|φ [symbol] |² between the second qubit and the first qubit is calculated, and is shown in the following formula (11):

$${\vert 〈 ϕ \vert φ 〉 \vert}^{2} = 2 Prob ( 0 ) - 1 \qquad ( 11 )$$

Here, the purpose of multiple measurements is to infer | [symbol] φ|φ [symbol] |². For example, in 100 times measurement, under a condition that |0 [symbol] is presented 60 times, the probability value that the measurement result is |0 [symbol] is

$$Prob ( 0 ) = \frac{1}{2} ( 1 + {\vert 〈 ϕ \vert φ 〉 \vert}^{2} ) = 0.6 ,$$

and thus, the quantum state fidelity of w_{N1} is calculated as | [symbol] φ|φ [symbol] |²=0.6×2−1=0.2.

On such basis, in some examples, the step of controlling the swap gate with the first intermediate-state qubit can specifically include:
under a condition that the first intermediate-state qubit is a first quantum state, controlling the swap gate to swap positions of the first qubit and the second qubit; and
under a condition that the first intermediate-state qubit is a second quantum state, controlling the swap gate to maintain the position of the first qubit and the position of the second qubit unchanged.

Here, the first quantum state can be |1 [symbol] , and the second quantum state can be |0 [symbol] . Specific control process examples can be referred to the corresponding sections of the above examples, such as the relevant explanatory part for expression (7), which is not repeated herein.

In some embodiments, in S160, after determining the quantum state fidelity between the second qubit and the first qubit, the loss value can be calculated according to the following formula (12):

$$C ( \vec{w} , \vec{b} ) = {\sum }_{m = 1}^{M} ( 1 - {\vert 〈 {ϕ}_{m} \vert {φ}_{m} 〉 \vert}^{2} ) \qquad ( 12 )$$

where C(\vec{w}, \vec{b}) is the loss value obtained by calculation under a condition of training the quantum neural network with the m-th piece of sample data; φₘ is the quantum state of the first qubit used in training the quantum neural network with the m-th piece of sample data; and φₘ is the quantum state of the second qubit obtained after training the quantum neural network with the m-th piece of sample data. | [symbol] φ|φ [symbol] |² represents similarity, and 1−| [symbol] φ|φ [symbol] |² denotes dissimilarity that is a difference degree, i.e., the loss value.

Here, formula (12) employs 1−| [symbol] φ|φ [symbol] |² to replace the conventional loss value calculation |y−y′|². For example, under a condition of | [symbol] φ|φ [symbol] |²=0.2, the loss value is 1−| [symbol] φ|φ [symbol] |²=0.8. By observing the change in the loss value, it is determined whether the quantum neural network converges, and the training stops until the quantum neural network converges. The loss value is configured to measure the difference degree between a predicted value |φ [symbol] of the quantum neural network and a true value |φ [symbol] of the quantum neural network. The smaller the loss value is, the better robustness of the quantum neural network is. After a single piece of sample data is input into the quantum neural network, the predicted value |φ [symbol] is output through a forward propagation, then a difference value between the predicted value and the actual value, i.e., the loss value, is calculated with the loss function. After obtaining the loss value, the quantum neural network updates the respective parameters, such as weights and bias items in the hidden layers, through backward propagation, so as to reduce the loss between the actual value and the predicted value to guide the predicted value generated by the quantum neural network towards the true value, thereby achieving the purpose of learning.

Additionally, in the embodiments of the present disclosure, a stochastic gradient descent (SGD) method can be employed to adjust the network parameter, which is specifically presented as follows:

$${b}_{mk} ← {b}_{mk} - η \frac{\partial c}{\partial {b}_{mk}}$$

$${w}_{nk} ← {w}_{nk} - η \frac{\partial c}{\partial {w}_{nk}}$$

where η is a custom learning rate.

The principle of SGD lies in updating the parameter using only one sample in each iteration update, i.e., updating with only one piece of sample data. In this way, since only one piece of sample data is adopted in each iteration, the training is faster. Compared to non-stochastic algorithms, SGD can utilize information more efficiently, particularly when information is redundant.

On such basis, in some specific examples, the process for training the quantum neural network can include: initializing a weight W and a bias b, which can be set to 0 or any random number; performing a forward propagation in which

$$\frac{\partial C}{\partial {b}_{mk}} and \frac{\partial C}{\partial {w}_{nk}}$$

are computed with the given piece of sample data \vec{xₘ} in combination with a weight W and a bias b of the hidden layer; performing a backward propagation in which a partial derivative is calculated and the weight W and the bias b are updated; inferring the loss value with a measured value and computing the loss value C; inputting the next piece of sample data \vec{xₘ₊₁}, repeating the above steps until all pieces of sample data in the training set Dₜᵣₐᵢₙ are processed, and completing one training round. Multiple training rounds are repeated while observing the change of the loss value, and the training stops until the loss value converges.

A method for classifying data provided by some embodiments of the present disclosure is described below.

FIG. 4 is a flowchart of a method for classifying data provided by an embodiment of the present disclosure. The trained quantum neural network used in the method for classifying data is obtained according to the method of training the quantum neural network provided in the aforementioned embodiments.

As shown in FIG. 4, the method for classifying data specifically includes the following steps:

In S410: target data to be classified is acquired, and inputting the target data into a quantum neural network, the quantum neural network including a feature extraction layer, a unitary matrix layer, and a quantum circuit.

In S420: feature extraction is performed on the target data using the feature extraction layer to obtain a target data feature.

In S430: the target data feature is input into the unitary matrix layer to obtain a unitary matrix corresponding to the target data feature.

In S440: a quantum state of a fifth qubit is adjusted based on the unitary matrix to obtain a sixth qubit.

In S450: a quantum state fidelity between the sixth qubit and the fifth qubit is determined using the quantum circuit.

In S460: a category to which the target data belongs is determined based on the quantum state fidelity.

Thus, the structure of the quantum neural network is improved by providing the feature extraction layer, the unitary matrix layer, and the quantum circuit in the quantum neural network. Then, during the process for data classification using the quantum neural network, the target data feature extracted from the feature extraction layer and corresponding to the target data to be classified is directly input into the unitary matrix layer, the unitary matrix corresponding to the target data feature is prepared to replace the preparation of quantum state data in the traditional method, the fifth qubit serves as a substitute for the activation function to allow the quantum state of the fifth qubit to be adjusted to be flipped by the unitary matrix, after obtaining the sixth qubit, a similarity comparison between the sixth qubit and the fifth qubit is performed by the quantum circuit to obtain the quantum state fidelity, and the category to which the target data belongs id determined based on the quantum state fidelity. In this way, in the embodiments of the present disclosure, data classification can be performed using the quantum neural network without quantum state preparation, quantum state data storage, or excessive qubits, which can reduce the training difficulty and complexity of the quantumneural network, and reduce the computational cost of the quantum neural network.

The following describes the specific implementation methods for each of the aforementioned steps.

In some embodiments, the aforementioned method for classifying data can be specifically applied to a scenario for predicting merchant lending risks. In this scenario, the target data to be classified can be data related to the merchant to be predicted.

Additionally, it should be noted that since steps S420 to S450 are identical or similar to the previously described steps S120 to S150, respectively, and are primarily to replace the sample data in S120 to S150 with the target data to be classified. Therefore, for the sake of brevity, the steps from S420 to S450 will not be elaborated herein, and the explanation provided for steps S120 to S150 also applicable to steps S420 to S450 in this embodiment.

Here, the fifth qubit is analogous to the first qubit in the preceding embodiments, and the sixth qubit is analogous to the second qubit in the preceding embodiments. The difference lies in that the quantum state of the fifth qubit can correspond to the category label of the category to which the target data preliminarily determined by the user based on experience is included. For example, if the target data that is preliminarily determined by the user based on experience should belong to the category a, the quantum state of the fifth qubit can correspond to the category label A corresponding to the category a. In this case, according to the aforementioned formula (2), the unit qubit with the quantum state |0 [symbol] can serve as the fifth qubit. The fifth qubit can also be a unit qubit with a default quantum state that is arbitrarily set by the user, and the default quantum state can be either |0 [symbol] or |1 [symbol] , which is not limited.

Furthermore, with respect to the aforementioned S460, in some embodiments, after determining and obtaining the quantum state fidelity between the sixth qubit and the fifth qubit, it is determined whether the target data belongs to the same category as the category label corresponding to the fifth qubit according to a magnitude of this quantum state fidelity. Subsequently, and then the category label to which the target data belongs can be determined by referencing the category label corresponding to the fifth qubit.

On such basis, in some embodiments, under a condition that the quantum state of the fifth qubit is a fourth quantum state and the fourth quantum state corresponds to a first category, the above S460 can specifically include:
under a condition that the quantum state fidelity is greater than a preset threshold, determining that the target data belongs to the first category; and
under a condition that the quantum state fidelity is not greater than the preset threshold, determining that the target data belongs to a second category other than the first category.

Here, the closer the quantum state fidelity | [symbol] φ|φ [symbol] |² is to 1, the more similar the quantum state of the sixth qubit is to the quantum state of the fifth qubit.

Taking the fourth quantum state being |1 [symbol] as an example, under a condition that the preset threshold is set to 0.5, | [symbol] φ|φ [symbol] |²>0.5 indicates that the sixth qubit is similar to the fifth qubit, i.e., the quantum state of the sixth qubit is also |1 [symbol] , and in this case, according to formula (2), the label B corresponding to the category |1 [symbol] to which the input target data belongs corresponds to the category b; and conversely, | [symbol] φ|φ [symbol] |²≤0.5 indicates that the sixth qubit is not similar to the fifth qubit, i.e., the quantum state of the sixth qubit is |0∛, and in this case, according to formula (2), the label A corresponding to the category |0∛ to which the input target data belongs corresponds to the category a. That is, the first category can be the category b corresponding to the label B, and the second category can be the category a corresponding to the label A, which can be specifically expressed as the following expression (13):

$${\vert 〈 ϕ \vert φ 〉 \vert}^{2} = \{ \begin{matrix}\leq 0.5 , & belong to label A \\ > 0.5 , & belong to label B\end{matrix} \qquad ( 13 )$$

Additionally, the fourth quantum state can also be set to |0 [symbol] . Under a condition that the fourth quantum state is |0 [symbol] , the process is similar to the above process, which is not repeated herein.

Additionally, in some embodiments, similar to the training process of the quantum neural network, the target data can include N feature data points corresponding to N dimensions, and the feature extraction layer can include K hidden units, where N and K are integers greater than 1.

On such basis, the aforementioned S420 can specifically include: inputting the N feature data points into each of the K hidden units, and performing feature extraction on the N feature data points using each of the K hidden units to obtain K sub-features, the target data feature including the K sub-features.

Correspondingly, the above S430 can specifically include: inputting the K sub-features into the unitary matrix layer to obtain K unitary matrices corresponding to the K sub-features.

Additionally, in some embodiments, the above S440 can specifically include: multiplying the K unitary matrices by the fifth qubit to obtain the sixth qubit.

It should be noted that the above process is similar to the process for processing the sample data during the above quantum neural network training, which is not repeated herein.

Additionally, in some embodiments, the quantum circuit can include a first Hadamard gate, a second Hadamard gate, and a swap gate, and the aforementioned S450 specifically includes:
inputting a preset seventh qubit into the first Hadamard gate, and outputting to obtain a third intermediate-state qubit;
inputting the fifth qubit and the sixth qubit into the swap gate, and controlling the swap gate with the third intermediate-state qubit, and outputting to obtain a fourth intermediate-state qubit;
inputting the fourth intermediate-state qubit into the second Hadamard gate, and outputting to obtain an eighth qubit;
measuring a quantum state of the eighth qubit multiple times to obtain measurement results;
determining, based on the measurement results, a probability value that the measurement results are a seventh quantum state, the seventh quantum state being a quantum state of the seventh qubit; and
calculating the quantum state fidelity between the sixth qubit and the fifth qubit based on the probability value.

Here, similar to the previously mentioned third qubit, the seventh qubit can also be a unit qubit with a quantum state |0 [symbol] or |1 [symbol] set by the user by default.

It should be noted that the above process is similar to the process of obtaining quantum state fidelity during the training of the aforementioned quantum neural network, which is not repeated herein.

Additionally, in some embodiments, the step of controlling the swap gate with the third intermediate-state qubit can specifically include:
under a condition that the third intermediate-state qubit is a fifth quantum state, controlling the swap gate to swap positions of the fifth qubit and the sixth qubit; and
under a condition that the third intermediate-state qubit is a sixth quantum state, controlling the swap gate to maintain the position of the fifth qubit and the position of sixth qubit unchanged.

Here, the fifth quantum state can be, for example, |1 [symbol] , and the sixth quantum state can be, for example, |0 [symbol] .

It should be noted that the above process is similar to the process of controlling the swap gate with the first intermediate-state qubit during above quantum neural network training, which is not repeated herein.

Additionally, in some embodiments, the expression for the unitary matrix layer can also be the aforementioned formula (3). The difference lies in that the input feature θ here can represent the target data feature. On such basis, in some embodiments, values of adjustment parameters α and β can be determined according to the data feature of the target data.

Combining the various embodiments and implementation methods described above, the quantum neural network structure provided by the present disclosure has the following three advantages.

A first advantage is that the present disclosure does not involve a quantum state preparation process. There is no need to pre-prepare data into quantum state; instead, data is directly applied to the unitary matrix, and the quantum state of the unit qubit is adjusted using the unitary matrix. The data in the present disclosure is not transformed into quantum state and still remains classical data, and each element in the unitary matrix is also classical data. That is, the classical data does not become quantum state data but becomes the unitary matrix. Each unitary matrix includes four elements, each of which is a real number (a trigonometric function) and has a value range between −1 and 1 (a data range of the trigonometric function). When these unitary matrices multiply qubits, the states of the qubits are changed, i.e., flipped. The classical data is not transformed into the qubits; but rather into tools for flipping qubits.

A second advantage is that the present disclosure does not require a quantum storage to store the quantum state data. Quantum storage is a major challenge in realizing quantum computing. The quantum system is inherently fragile, and the slightest disturbance from the external world may cause the entire system state to collapse. This characteristic makes quantum state data difficult to store, because it is hard to determine whether the input information has been successfully preserved. Since quantum information cannot be copied or amplified, the quantum storage plays a more important role in quantum information than classical storage does in classical information. In the present disclosure, data is still data, and the unitary matrix also involves conventional data, without involving quantum state data. Therefore, the quantum state data storage is unnecessary. It is important to note that the present disclosure still needs to be executed on a quantum computer, as it involves unit qubit. Thus, quantum storage is still needed to store qubits without storing quantum state data.

A third advantage is that the present disclosure requires very few qubits (up to 3), resulting in a low cost and preventing the barren plateaus phenomenon. The number of bits in the quantum computer is positively correlated with computational cost, and algorithms requiring more qubits have higher computational costs. For current common quantum neural networks, the number of required qubits is typically P or log P, where P is a feature dimension. Therefore, under a condition that the feature dimension of the sample data is large, for example, 200 features, 200 qubits are typically required. The barren plateaus phenomenon refers to a situation where, when the number of qubits is relatively large (e.g., greater than 10), a framework of traditional quantum neural network easily becomes ineffective for training. The objective function becomes very flat, making gradients difficult to estimate.

It should be noted that the usage scenarios described in the embodiments of the present disclosure are intended to clarify the technical solutions provided in the embodiments of the present disclosure and do not constitute limitations on the technical solution provided in embodiments of the present disclosure. As can be known to those skilled in the art, with the emergence of new application scenarios, the technical solutions provided by the embodiments of the present disclosure are also applicable to similar technical problems.

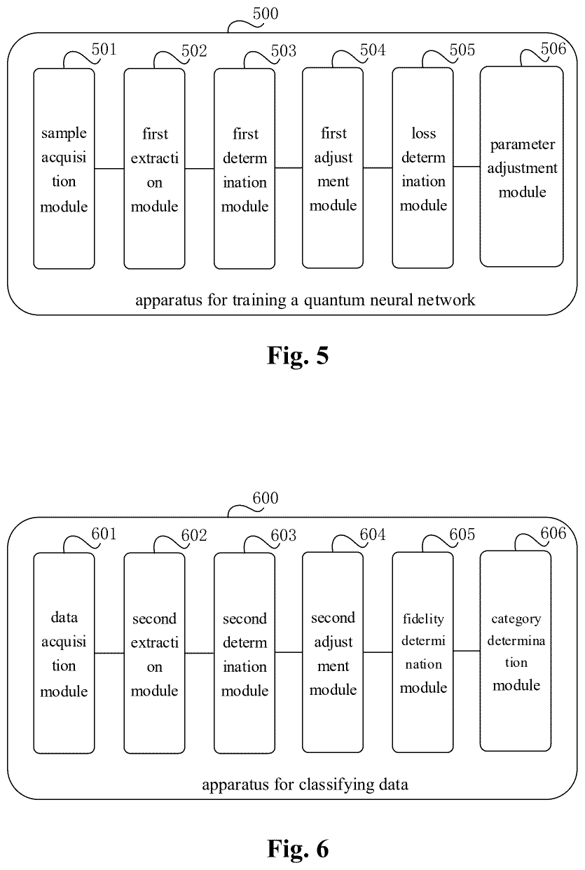

Based on the same inventive concept, the present disclosure provides an apparatus for training a quantum neural network. Detailed description is provided with reference to FIG. 5.

FIG. 5 is a schematic structural diagram of an apparatus for training a quantum neural network provided by an embodiment of the present disclosure.

As shown in FIG. 5, the apparatus 500 for training the quantum neural network includes:
a sample acquisition module 501, configured to acquire sample data for training the quantum neural network and a sample category label corresponding to the sample data, the quantum neural network comprising a feature extraction layer, a unitary matrix layer, and a quantum circuit;
a first extraction module 502, configured to perform feature extraction on the sample data using the feature extraction layer to obtain a sample feature;
a first determination module 503, configured to input the sample feature into the unitary matrix layer to obtain a unitary matrix corresponding to the sample feature;
a first adjustment module 504, configured to adjust a quantum state of a first qubit based on the unitary matrix to obtain a second qubit, the quantum state of the first qubit corresponding to the sample category label;
a loss determination module 505, configured to determine a quantum state fidelity between the second qubit and the first qubit using the quantum circuit, and determine a loss value based on the quantum state fidelity; and
a parameter adjustment module 506, configured to adjust a network parameter in the quantum neural network based on the loss value, and return to execute the acquiring the sample data for training the quantum neural network and the sample category label corresponding to the sample data until the quantum neural network converges, so as to obtain the trained quantum neural network.

The following provides a detailed description of the apparatus 500 for training the quantum neural network as described above.

In some embodiments, the sample data includes N feature data points corresponding to N dimensions, and the feature extraction layer includes K hidden units, where N and K are integers greater than 1; the first extraction module 502 is specifically configured to: input the N feature data points into each of the K hidden units, and perform feature extraction on the N feature data points using each of the K hidden units to obtain K sample sub-features, the sample feature including the K sample sub-features; and the first determination module 503 is specifically configured to input the K sample sub-features into the unitary matrix layer to obtain K unitary matrices corresponding to the K sample sub-features.

In some embodiments, the first adjustment module 504 is specifically configured to multiply the K unitary matrices by the first qubit to obtain the second qubit.

In some embodiments, the quantum circuit includes a first Hadamard gate, a second Hadamard gate, and a swap gate, and the loss determination module 505 includes:
a first input sub-module, configured to input a preset third qubit into the first Hadamard gate to output a first intermediate-state qubit;
a second input sub-module, configured to input the first qubit and the second qubit into the swap gate, control the swap gate with the first intermediate-state qubit, and output a second intermediate-state qubit;
a third input sub-module, configured to input the second intermediate-state qubit into the second Hadamard gate and output a fourth qubit;
a first measurement sub-module, configured to measuring a quantum state of the fourth qubit multiple times to obtain measurement results;
a first processing sub-module, configured to determine a probability value that the measurement results are a third quantum state based on the measurement results, the third quantum state being a quantum state of the third qubit; and
a first computation sub-module, configured to calculate the quantum state fidelity between the first qubit and the second qubit based on the probability value.

In some embodiments, the second input sub-module includes:
a first control unit, configured to control the swap gate to swap positions of the first qubit and the second qubit under a condition that the first intermediate-state qubit is a first quantum state;
a second control unit, configured to control the swap gate to maintain the position of the first qubit and the position of the second qubit unchanged under a condition that the first intermediate-state qubit is a second quantum state.

In some embodiments, the expression for the unitary matrix layer is:

$$U ( θ ) = [ \begin{matrix}α \cdot cos ( θ ) & β \cdot sin ( θ ) \\ - {β}^{- 1} \cdot sin ( θ ) & {α}^{- 1} \cdot cos ( θ )\end{matrix} ] ,$$

where α and β represent adjustment parameters, θ represents an input feature, and U(θ) represents the unitary matrix.

In some embodiments, a value of each of the adjustment parameters is determined based on a data feature of the sample data.

Therefore, the structure of the quantum neural network is improved by providing the feature extraction layer, the unitary matrix layer, and the quantum circuit in the quantum neural network. Then, during the training process, the sample feature extracted from the feature extraction layer and corresponding to the sample data is directly input into the unitary matrix layer, the unitary matrix corresponding to the sample feature is prepared to replace the preparation of quantum state data in the traditional method, the first qubit serves as a substitute for the activation function to allow the quantum state of the first qubit to be adjusted to be flipped by the unitary matrix, and after obtaining the second qubit, a similarity comparison between the second qubit and the first qubit is performed by the quantum circuit to calculate the loss function. In this way, in the embodiments of the present disclosure, the quantum neural network can be obtained through training without quantum state preparation, quantum state data storage, or excessive qubits, which can reduce the training difficulty and complexity of the quantum neural network, reduce the computational cost of the quantum neural network, and reduce the probability of occurring of the barren plateaus phenomenon.

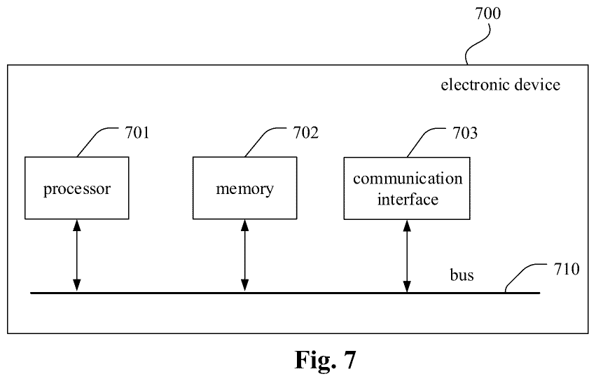

Additionally, the present disclosure also provides an apparatus for classifying data. Detailed description is provided with reference to FIG. 6.

FIG. 6 is a schematic structural diagram of an apparatus for classifying data provided by an embodiment of the present disclosure.

As shown in FIG. 6, the apparatus 600 for classifying data can include:
a data acquisition module 601, configured to acquire target data to be classified, and input the target data into a quantum neural network, the quantum neural network including a feature extraction layer, a unitary matrix layer, and a quantum circuit;
a second extraction module 602, configured to perform feature extraction on the target data using the feature extraction layer to obtain a target data feature;
a second determination module 603, configured to input the target data feature into the unitary matrix layer to obtain a unitary matrix corresponding to the target data feature;
a second adjustment module 604, configured to adjust a quantum state of a fifth qubit based on the unitary matrix to obtain a sixth qubit;
a fidelity determination module 605, configured to determine a quantum state fidelity between the sixth qubit and the fifth qubit using the quantum circuit; and
a category determination module 606, configured to determine a category to which the target data belongs based on the quantum state fidelity.

The following provides a detailed description of the apparatus 600 for classifying data, and details are presented below.

In some embodiments, under a condition that the quantum state of the fifth qubit is a fourth quantum state and the fourth quantum state corresponds to a first category, the category determination module 606 includes:
a first determination sub-module, configured to determine that the target data belongs to the first category under a condition that the quantum state fidelity is greater than a preset threshold; and
a second determination sub-module, configured to determine that the target data belongs to a second category other than the first category under a condition that the quantum state fidelity is not greater than the preset threshold.

In some embodiments, the target data includes N feature data points corresponding to N dimensions, and the feature extraction layer includes K hidden units, where N and K are integers greater than 1; on such basis, the second extraction module 602 is specifically configured to input the N feature data points into each of the K hidden units, and perform feature extraction on the N feature data points using each of the K hidden units to obtain K sub-features, the target data feature including the K sub-features; and the second determination module 603 is specifically configured to input the K sub-features into the unitary matrix layer to obtain K unitary matrices corresponding to the K sub-features.

In some embodiments, the second adjustment module 604 is specifically configured to multiply the K unitary matrices by the fifth qubit to obtain the sixth qubit.

In some embodiments, the quantum circuit includes a first Hadamard gate, a second Hadamard gate, and a swap gate; and on such basis, the fidelity determination module 605 includes:
a fourth input sub-module, configured to input a preset seventh qubit into the first Hadamard gate, and output a third intermediate-state qubit;
a fifth input sub-module, configured to input the fifth qubit and the sixth qubit into the swap gate, and control the swap gate with the third intermediate-state qubit, and output a fourth intermediate-state qubit;
a sixth input sub-module, configured to input the fourth intermediate-state qubit into the second Hadamard gate, and output an eighth qubit;
a second measurement sub-module, configured to measure a quantum state of the eighth qubit multiple times to obtain measurement results;
a second processing sub-module, configured to determine a probability value that the measurement results are a seventh quantum state based on the measurement results, the seventh quantum state being a quantum state of the seventh qubit; and
a second computation sub-module, configured to calculate the quantum state fidelity between the sixth qubit and the fifth qubit based on the probability value.

In some embodiments, the fifth input sub-module includes:
a third control unit, configured to control the swap gate to swap positions of the fifth qubit and the sixth qubit under a condition that the third intermediate-state qubit is a fifth quantum state; and
a fourth control unit, configured to control the swap gate to maintain the position of the fifth qubit and the position of sixth qubit unchanged under a condition that the third intermediate-state qubit is a sixth quantum state.

In some embodiments, the expression for the unitary matrix layer is:

$$U ( θ ) = [ \begin{matrix}α \cdot cos ( θ ) & β \cdot sin ( θ ) \\ - {β}^{- 1} \cdot sin ( θ ) & {α}^{- 1} \cdot cos ( θ )\end{matrix} ] ,$$

where α and β represent adjustment parameters, θ represents an input feature, and U(θ) represents the unitary matrix.

In some embodiments, a value of each of the adjustment parameters is determined based on a data feature of the target data.

Thus, the structure of the quantum neural network is improved by providing the feature extraction layer, the unitary matrix layer, and the quantum circuit in the quantum neural network. Then, during the process for data classification using the quantum neural network, the target data feature extracted from the feature extraction layer and corresponding to the target data to be classified is directly input into the unitary matrix layer, the unitary matrix corresponding to the target data feature is prepared to replace the preparation of quantum state data in the traditional method, the fifth qubit serves as a substitute for the activation function to allow the quantum state of the fifth qubit to be adjusted to be flipped by the unitary matrix, and after obtaining the sixth qubit, a similarity comparison between the sixth qubit and the fifth qubit is performed by the quantum circuit to obtain the quantum state fidelity, and the category to which the target data belongs id determined based on the quantum state fidelity. In this way, in the embodiments of the present disclosure, data classification can be performed using the quantum neural network without quantum state preparation, quantum state data storage, or excessive qubits, which can reduce the training difficulty and complexity of the quantumneural network, and reduce the computational cost of the quantum neural network.

FIG. 7 is a schematic structural diagram of an electronic device provided by an embodiment of the present disclosure.

The electronic device 700 can include a processor 701 and a memory 702 storing computer program instructions.

Specifically, the processor 701 can include a central processing unit (CPU), an application specific integrated circuit (ASIC), or one or more integrated circuits configured to implement the embodiments of the present disclosure.

The memory 702 can include a mass storage device for data or instructions. For example, without limitation, the memory 702 can include a hard disk drive (HDD), floppy disk drive, flash memory, optical disk, magneto-optical disk, magnetic tape, or a universal serial bus (USB) drive, or a combination of two or more thereof. Where appropriate, the memory 702 can include removable or non-removable (or fixed) media. Where appropriate, the memory 702 can be located inside or outside an integrated gateway disaster recovery device. In particular embodiments, the memory 702 is non-volatile solid-state storage.

In particular embodiments, the memory can include a read-only memory (ROM), a random access memory (RAM), a disk storage media device, an optical storage media device, a flash memory device, an electrical, optical, or other physical/tangible memory storage device. Thus, typically, the memory includes one or more tangible (non-transient) computer-readable storage media (e.g., storage devices) encoded with software including computer-executable instructions, and when the software is executed (e.g., by one or more processors), it is operable to perform operations described in reference to the methods according to one aspect of the present disclosure.

The processor 701 implements any one of the method for training the quantum neural network and the method for classifying data described in the above embodiments by reading and executing computer program instructions stored in the memory 702.

In some examples, the electronic device 700 can include a communication interface 703 and a bus 710. As shown in FIG. 7, the processor 701, the memory 702, and the communication interface 703 are connected via the bus 710 to communicate with each other.

The communication interface 703 is primarily configured to implement the communication between various modules, apparatuses, units, and/or devices in the embodiments of the present disclosure.

The bus 710 includes hardware, software, or both, which couples the components of an online data traffic metering device together. For example, without limitation, the bus 710 can include an accelerated graphics port (AGP) or other graphics bus, an enhanced industrial standard architecture (EISA) bus, a front side bus (FSB), hyper transport (HT) interconnection, an industrial standard architecture (ISA) bus, unlimited bandwidth interconnect, a low pin count (LPC) bus, a memory bus, a micro channel architecture (MCA) bus, a peripheral component interconnect (PCI) bus, a PCI-Express (PCI-X) bus, a serial advanced technology attachment (SATA) bus, a video electronics standards association local bus (VLB) bus, or other suitable buses, or a combination of two or more thereof. Where appropriate, bus 710 can include one or more buses. Although specific buses are described and illustrated in the embodiments of the present disclosure, the present disclosure takes any suitable bus or interconnect into account.

Exemplarily, the electronic device 700 can be a mobile phone, a tablet computer, a laptop computer, a handheld computer, an on-vehicle electronic device, an ultra-mobile personal computer (UMPC), a netbook, or a personal digital assistant (PDA), or the like.

The electronic device 700 can execute the method for training the quantum neural network and/or the method for classifying data described in the embodiments of the present disclosure, thereby implementing the method and apparatus for training the quantum neural network, and/or the method or apparatus for classifying data described in FIGS. 1 to 6.

Additionally, in conjunction with the method for training the quantum neural network and/or the method for classifying data described in the above embodiments, the present disclosure can provide a computer-readable storage medium for implementation. The computer-readable storage medium stores computer program instructions, and when executed by a processor, the computer program instructions implement any one of the method for training the quantum neural network and/or the method for classifying data described in the above embodiments. Examples of the computer-readable storage media include a non-transitory computer-readable storage medium such as portable disks, hard disks, random access memory (RAM), read-only memory (ROM), erasable programmable read-only memory (EPROM or flash memory), portable compact disc read-only memory (CD-ROM), optical storage devices, or magnetic storage devices.

It should be understood that the present disclosure is not limited to the specific configurations and processes described above and illustrated in the figures. For the sake of brevity, detailed descriptions of known methods have been omitted. In the above embodiments, several specific steps are described and illustrated as examples. However, the method processes of the present disclosure are not limited to the specific steps described and illustrated. Those skilled in the art, upon understanding the gist of the present disclosure, can make various changes, modifications, and additions, or alter the order of the steps.

The functional blocks illustrated in the above structural block diagram can be implemented as a hardware, a software, a firmware, or a combination thereof. When implemented as hardware, it can be, for example, an electronic circuit, an application specific integrated circuit (ASIC), an appropriate firmware, a plug-in, a function card, etc. When implemented as software, the elements of the present disclosure are programs or code segments used to perform the required tasks. The programs or code segments can be stored on a machine-readable medium or transmitted on a transmission medium or a communication link via data signals carried by a carrier. “Machine-readable media” can include any medium capable of storing or transmitting information. Examples of machine-readable media include an electronic circuit, a semiconductor memory device, a ROM, a flash memory, an erasable ROM (EROM), a floppy disk, a CD-ROM, an optical disk, a hard disk, a fiber optic media, a radio frequency (RF) link, etc. Code segments can be downloaded via computer networks such as the Internet or intranets.

It should also be noted that the exemplary embodiments described herein describe certain methods or systems based on a series of steps or apparatuses. However, the present disclosure is not limited to the sequence of steps described above. That is, the steps can be performed in the order described in the embodiments or in an order different from the order described in the embodiments, or multiple steps can be performed simultaneously.

The various aspects of the present disclosure have been described with reference to flowcharts and/or block diagrams illustrating methods, apparatuses (systems), and computer program products according to embodiments of the present disclosure. It should be understood that each box in the flowcharts and/or block diagrams, and combinations of boxes in the flowcharts and/or block diagrams, can be implemented by computer program instructions. These computer program instructions can be provided to a processor of a general-purpose computer, a dedicated computer, or other programmable data processing apparatus to produce a machine, so that the instructions, when executed by the processor of the computer or other programmable data processing apparatus, implement the functions/actions specified in one or more boxes of the flowchart and/or block diagram. Such processor can be, but is not limited to, a general-purpose processor, a dedicated processor, a special application processor, or a field programmable logic device. It is also understood that each block in the block diagram and/or flowchart, as well as combinations of blocks in the block diagram and/or flowchart, can also be implemented by dedicated hardware performing the specified function or action, or by a combination of dedicated hardware and computer instructions.

The foregoing describes specific embodiments of the present disclosure. Those skilled in the art will readily appreciate that, for the sake of description and brevity, the specific operational processes of the systems, modules, and units described above can be understood with reference to the corresponding processes in the preceding method embodiments and are not repeated herein. It should be understood that the protection scope of the present disclosure is not limited to the above. Those skilled in the art can readily conceive various equivalent modifications or replacements within the scope of the disclosed technology, and such modifications or replacements should fall within the protection scope of the present disclosure.

1. A method for training a quantum neural network, comprising:
acquiring sample data for training the quantum neural network and a sample category label corresponding to the sample data, the quantum neural network comprising a feature extraction layer, a unitary matrix layer, and a quantum circuit;
performing feature extraction on the sample data using the feature extraction layer to obtain a sample feature;
inputting the sample feature into the unitary matrix layer to obtain a unitary matrix corresponding to the sample feature;
adjusting a quantum state of a first qubit based on the unitary matrix to obtain a second qubit, the quantum state of the first qubit corresponding to the sample category label;
determining a quantum state fidelity between the second qubit and the first qubit using the quantum circuit, and determining a loss value based on the quantum state fidelity; and
adjusting a network parameter in the quantum neural network based on the loss value, and returning to execute the acquiring the sample data for training the quantum neural network and the sample category label corresponding to the sample data until the quantum neural network converges, so as to obtain the trained quantum neural network.

2. The method according to claim 1, wherein the sample data comprises N feature data points corresponding to N dimensions, and the feature extraction layer comprises K hidden units, where N and K are integers greater than 1;
the performing feature extraction on the sample data using the feature extraction layer to obtain the sample feature comprises:
inputting the N feature data points into each of the K hidden units, and performing feature extraction on the N feature data points using each of the K hidden units to obtain K sample sub-features, the sample feature comprising the K sample sub-features;
the inputting the sample feature into the unitary matrix layer to obtain a unitary matrix corresponding to the sample feature comprises:
inputting the K sample sub-features into the unitary matrix layer to obtain K unitary matrices corresponding to the K sample sub-features.

3. The method according to claim 2, wherein the adjusting the quantum state of the first qubit based on the unitary matrix to obtain the second qubit comprises:
multiplying the K unitary matrices by the first qubit to obtain the second qubit.

4. The method according to claim 1, wherein the quantum circuit comprises a first Hadamard gate, a second Hadamard gate, and a swap gate;
the determining the quantum state fidelity between the second qubit and the first qubit using the quantum circuit comprises:
inputting a preset third qubit into the first Hadamard gate to output a first intermediate-state qubit;
inputting the first qubit and the second qubit into the swap gate, controlling the swap gate with the first intermediate-state qubit, and outputting a second intermediate-state qubit;
inputting the second intermediate-state qubit into the second Hadamard gate and outputting a fourth qubit;
measuring a quantum state of the fourth qubit multiple times to obtain measurement results;
determining a probability value that the measurement results are a third quantum state based on the measurement results, the third quantum state being a quantum state of the third qubit; and
calculating the quantum state fidelity between the first qubit and the second qubit based on the probability value.

5. The method according to claim 4, wherein the controlling the swap gate with the first intermediate-state qubit comprises:
under a condition that the first intermediate-state qubit is a first quantum state, controlling the swap gate to swap positions of the first qubit and the second qubit;
under a condition that the first intermediate-state qubit is a second quantum state, controlling the swap gate to maintain the position of the first qubit and the position of the second qubit unchanged.

6. The method according to claim 1, wherein an expression for the unitary matrix layer is:
$$U ( θ ) = [ \begin{matrix}α \cdot cos ( θ ) & β \cdot sin ( θ ) \\ - {β}^{- 1} \cdot sin ( θ ) & {α}^{- 1} \cdot cos ( θ )\end{matrix} ] ,$$
where α and β represent adjustment parameters, θ represents an input feature, and U(θ) represents the unitary matrix.

7. The method according to claim 6, wherein a value of each of the adjustment parameters is determined based on a data feature of the sample data.

8. A method for classifying data, comprising:
acquiring target data to be classified, and inputting the target data into a quantum neural network, the quantum neural network comprising a feature extraction layer, a unitary matrix layer, and a quantum circuit;
performing feature extraction on the target data using the feature extraction layer to obtain a target data feature;
inputting the target data feature into the unitary matrix layer to obtain a unitary matrix corresponding to the target data feature;
adjusting a quantum state of a fifth qubit based on the unitary matrix to obtain a sixth qubit;
determining a quantum state fidelity between the sixth qubit and the fifth qubit using the quantum circuit; and
determining a category to which the target data belongs based on the quantum state fidelity.

9. The method according to claim 8, wherein under a condition that the quantum state of the fifth qubit is a fourth quantum state and the fourth quantum state corresponds to a first category, the determining the category to which the target data belongs based on the quantum state fidelity comprises:
under a condition that the quantum state fidelity is greater than a preset threshold, determining that the target data belongs to the first category; and
under a condition that the quantum state fidelity is not greater than the preset threshold, determining that the target data belongs to a second category other than the first category.

10. The method according to claim 8, wherein the target data comprises N feature data points corresponding to N dimensions, and the feature extraction layer comprises K hidden units, where N and K are integers greater than 1;
the performing feature extraction on the target data using the feature extraction layer to obtain the target data feature, comprises:
inputting the N feature data points into each of the K hidden units, and performing feature extraction on the N feature data points using each of the K hidden units to obtain K sub-features, the target data feature comprising the K sub-features; and
the inputting the target data feature into the unitary matrix layer to obtain the unitary matrix corresponding to the target data feature comprises:
inputting the K sub-features into the unitary matrix layer to obtain K unitary matrices corresponding to the K sub-features.

11. The method according to claim 10, wherein the adjusting the quantum state of the fifth qubit based on the unitary matrix to obtain the sixth qubit comprises:
multiplying the K unitary matrices by the fifth qubit to obtain the sixth qubit.

12. The method according to claim 8, wherein the quantum circuit comprises a first Hadamard gate, a second Hadamard gate, and a swap gate;
the determining the quantum state fidelity between the sixth qubit and the fifth qubit using the quantum circuit comprises:
inputting a preset seventh qubit into the first Hadamard gate, and outputting a third intermediate-state qubit;
inputting the fifth qubit and the sixth qubit into the swap gate, and controlling the swap gate with the third intermediate-state qubit, and outputting a fourth intermediate-state qubit;
inputting the fourth intermediate-state qubit into the second Hadamard gate, and outputting an eighth qubit;
measuring a quantum state of the eighth qubit multiple times to obtain measurement results;
determining a probability value that the measurement results are a seventh quantum state based on the measurement results, the seventh quantum state being a quantum state of the seventh qubit; and
calculating the quantum state fidelity between the sixth qubit and the fifth qubit based on the probability value.

13. The method according to claim 12, wherein the controlling the swap gate with the third intermediate-state qubit comprises:
under a condition that the third intermediate-state qubit is a fifth quantum state, controlling the swap gate to swap positions of the fifth qubit and the sixth qubit;
under a condition that the third intermediate-state qubit is a sixth quantum state, controlling the swap gate to maintain the position of the fifth qubit and the position of sixth qubit unchanged.

14. The method according to claim 8, wherein an expression for the unitary matrix layer is:
$$U ( θ ) = [ \begin{matrix}α \cdot cos ( θ ) & β \cdot sin ( θ ) \\ - {β}^{- 1} \cdot sin ( θ ) & {α}^{- 1} \cdot cos ( θ )\end{matrix} ] ,$$
where α and β represent adjustment parameters, θ represents an input feature, and U(θ) represents the unitary matrix.

15. The method according to claim 14, wherein a value of each of the adjustment parameters is determined based on a data feature of the target data.

16. An apparatus for training a quantum neural network, comprising:
a sample acquisition module, configured to acquire sample data for training the quantum neural network and a sample category label corresponding to the sample data, the quantum neural network comprising a feature extraction layer, a unitary matrix layer, and a quantum circuit;
a first extraction module, configured to perform feature extraction on the sample data using the feature extraction layer to obtain a sample feature;
a first determination module, configured to input the sample feature into the unitary matrix layer to obtain a unitary matrix corresponding to the sample feature;
a first adjustment module, configured to adjust a quantum state of a first qubit based on the unitary matrix to obtain a second qubit, the quantum state of the first qubit corresponding to the sample category label;
a loss determination module, configured to determine a quantum state fidelity between the second qubit and the first qubit using the quantum circuit, and determine a loss value based on the quantum state fidelity; and
a parameter adjustment module, configured to adjust a network parameter in the quantum neural network based on the loss value, and return to execute the acquiring the sample data for training the quantum neural network and the sample category label corresponding to the sample data until the quantum neural network converges, so as to obtain the trained quantum neural network.

17. (canceled)

18. An electronic device, comprising:
a processor; and
a memory storing computer program instructions,
wherein the processor, when executing the computer program instructions, implements the steps of the method for training the quantum neural network according to claim 1.

19. A non-transitory computer-readable storage medium storing computer program instructions, wherein the computer program instructions, when executed by a processor, implement the steps of the method for training the quantum neural network according to claim 1.

20. (canceled)
